(19) United States
(12) Patent Application Publication
(10) Pub. No.: US 2002/0121352 A1
(43) Pub. Date: Sep. 5, 2002

(54) Electrical field apparatus and methods for fluid for decontamination and other purposes

(76) Inventors: J. Alan Lawson, Dublin, GA (US); Ahmed A. BaOsman, Atlanta, GA (US); Jeffrey S. Hsieh, Marietta, GA (US)

Correspondence Address: SUTHERLAND ASBILL & BRENNAN LLP, 999 PEACHTREE STREET, N.E., ATLANTA, GA, 30309, US

(21) Appl. No.: 10/090,870

(22) Filed: Mar. 4, 2002

Related U.S. Application Data
(60) Provisional application No. 60/273,025, filed on Mar. 2, 2001.
(60) Provisional application No. 60/311,171, filed on Jul. 30, 2001.

(51) Int. Cl. B03C 5/00; B03C 7/00; C25B 9/00

(52) U.S. Cl. 162/192; 162/55; 162/189; 209/12.2; 209/127.1; 162/128; 204/554; 204/660

(57) ABSTRACT

Methods and devices are provided for treating a fluid with a high voltage electric field for decontaminating the fluid or a variety of other purposes. In a preferred embodiment for decontamination, the method includes (a) applying an electric field across a fluid having contaminants dispersed therein; and then (b) flowing the fluid through a decontamination cell to separate from the fluid at least a portion of the contaminants. An apparatus for use with this method preferably includes an electropotential cell comprising a housing containing an anode and a cathode for applying an electric field to a fluid flowing through the housing, a decontamination cell in fluid communication with the electropotential cell for separating from the fluid at least a portion of any contaminants dispersed therein, and an optional means for introducing gas bubbles into the fluid before the fluid flows to the electropotential cell.

CROSS-REFERENCE TO RELATED APPLICATIONS

Priority is claimed under 35 U.S.C. § 119 to U.S. Ser. No. 60/273,025, filed Mar. 2, 2001, and to U.S. Ser. No. 60/311,171, filed Jul. 30, 2001.

### FIELD OF THE INVENTION

The present invention generally relates to methods and devices for use in treating fluids with a high voltage electrical field, particularly paper pulp suspensions in a recycling process, for decontamination and/or other treatment of the fluid or solids dispersed therein.

### BACKGROUND OF THE INVENTION

A major limitation to the use of recycled paper pulp materials is the effective removal of inks, adhesives, and other constituents used in the prior product. Examples of these prior products include old newsprint, recycled corrugated containers and linerboard, and office waste. Recycled pulp from these sources commonly includes flexographic ink, microstickies, toner ink particles, and various dyes. These contaminants also are commonly present in paper machine effluent. Various chemical and mechanical technologies are used to try to separate these contaminants. Current separation technologies have met with only limited success. For example, flexographic ink, which used in printing some 585,000 metric tons of newsprint annually, cannot be easily removed by traditional flotation and washing procedures. Moreover, many paper mills limit the amount of flexographic ink from recycled paper to no more than 5 to 15%, and controlling the exact quantity of flexographic ink in the pulp is difficult.

Another contaminant that is difficult to separate and control is stickies, particularly microstickies. Micro-sticky contaminant particles common in all recycled paper slurries cause paper machine production problems. In particular, old corrugated cardboard materials contain a high level of adhesives, such as microstickies. Microstickies content in all grades of recycled paper has risen with the increasing use of pressure sensitive adhesives, for example, in POST-IT™ notes and stamps. Microsticky particles cause holes in the paper product, decreasing it quality and value. These particles also plug paper machine felts and wires, reducing the ability of these components to drain water effectively and thereby reducing the service life of the felts and wires. This leads to undesirably frequent and costly machine shutdowns for maintenance and thus to increase production costs.

It therefore would be advantageous to develop improved methods and devices for separating flexographic inks and microsticky particles, as well as other problematic particles such as colloidal waxes, laser/toner inks, pitch, and dirt, from the recycled pulp. Biological contaminants also need to be removed or neutralized. Effective separation of these contaminants is needed to render the pulp suitable for paper production and to enhance the value of that paper.

These contaminants are particularly difficult to remove when they are present as very small, highly dispersed particles. In fact, some processes may exacerbate this problem. For example, mechanical shear forces used to dislodge contaminant particles from the paper fibers also break those particles into more and smaller particles. These micron-size contaminant particles are particularly difficult to remove using currently available technologies. The “particle count” of these contaminant particles is one measure for quantifying the degree to which such particles are present in a quantity of pulp suspension. Increased particle count occurs with pumping and agitation of contaminated pulp slurries that breaks the contaminant particles into smaller particles.

An undesirable consequence of increased particle count is that the optical brightness of the paper made from these pulps will decrease. Lower optical brightness is highly undesirable, and reduces the value of the paper. Current methods for removing specific contaminants from various liquid suspensions and aqueous solutions, such as recycled paper pulps or paper machine effluent, are not as effective as desired, particularly when the contaminants are highly dispersed in the fluid and have a small particle size. Consequently, it would be greatly advantageous to develop improved methods and equipment for enhancing decontamination, which, when applied to a contaminated pulp suspension, can decrease the particle count and increase optical brightness of paper made from that pulp.

As mentioned above, biological contaminants in pulp suspensions need to be separated or treated. In fact, there is a need for biologic neutralization of many aqueous solutions and suspensions in pulp and paper mill processes. For example, the high temperatures of paper stocks create an opportunistic breeding environment for microorganisms, such as bacteria, yeast and fungi. Methods and apparatus for neutralization, or killing, of these microorganisms are needed. Grey water sterilization in paper mills would greatly aid in the proper disposal of wastewater. Certain wood types may be predisposed to infections by parasitic organisms, such as nematodes in soft woods, which would be desirable to kill before shipping the wood products. Any liquid suspension containing undesirable living organisms would benefit from an improved method of neutralizing such organisms. It would be particularly advantageous to provide a method that is effective without the need to add biocides and fungicides into the paper process, especially where such chemicals require approval of the FDA.

U.S. Pat. No. 5,238,538 discloses a method for deinking recycled fibers using a cell with a central anode and a perimeteral cathode. A fiber slurry flowing through the cell is subjected to a direct current electrical field, which causes the ink to be directed away from the fiber surface. Separation of the ink from the pulp fiber network is enhanced by electrocoagulation of the ink. Gas bubbles that are generated in the slurry during application of the electric field also facilitate separation by carrying ink particles to the surface of the slurry as the bubbles rise though the slurry. Such methods, however, have a need for improvement in areas such as electrode cleaning during de-inking, electrode surface area verses power consumption, and anode/cathode geometry. It also would be desirable to enhance the efficiency of contaminant separation.

There are numerous disclosures of using an electric field to decontaminant, sterilize, or cause some physical or chemical change in a fluid. Many of these techniques, however, have not been commercially feasibly due to limitations in controlling a high-voltage electric field and attendant high power consumption. For example, if the electric field is not controlled, the fluid may be undesirably vaporized. Additionally, known electrode configurations may be operable only at prohibitively high amperage and power costs. There is a need for an electropotential cell design that is simple, reliable, and cost effective.

U.S. Pat. No. 5,733,413 discloses methods and devices for decontaminating an aqueous pulp suspension by flowing the suspension through a decontamination cell that utilizes pulp head and difference in specific gravity to separate heavy and light contaminants from the pulp. It would be advantageous to improve this technology to better remove microstickies and other contaminants that are not easily removed using this decontamination cell.

It is therefore an object of the present invention to provide devices and methods for separating inks, microstickies, and other contaminants from recycled pulp slurries.

It is another object of the present invention to provide devices and methods for neutralizing undesirable living organisms present in an aqueous suspension or solution, particularly pulp suspensions, waste water, and other industrial effluents.

It is a further object of the present invention to provide improved devices and means for the controlled application of high voltage electric fields to fluids for decontaminating the fluid and for a variety of other purposes.

It is still another object of the present invention to decontaminate recycled pulp or other slurries and fluids efficiently and in a cost-effective continuous process, preferably with a shorter pulp mill sequence.

It is yet a further object of the present invention to provide methods for treating recycled pulp that provide better rates of contaminant removal, high quality pulp, better paper machine runnability, increased paper sheet brightness and strength, less use of biocides, and simpler and less expensive deinking chemistry, than available from the use of current deinking technologies.

These and other objects, features, and advantages of the present invention will become apparent upon review of the following detailed description of the invention taken in conjunction with the drawings and the appended claims.

### SUMMARY OF THE INVENTION

Improved methods and devices are provided for treating a fluid with a high voltage electric field for decontaminating the fluid or a variety of other purposes. Preferably, the method includes the steps of (a) applying an electric field across a fluid having contaminants dispersed therein; and (b) flowing the fluid through a decontamination cell to separate from the fluid at least a portion of the contaminants. An apparatus for use with this method is also provided. It includes an electropotential cell comprising a housing containing an anode and a cathode for applying an electric field to a fluid flowing through the housing, a decontamination cell in fluid communication with the electropotential cell for separating from the fluid at least a portion of any contaminants dispersed therein, and an optional means for introducing gas bubbles into the fluid before the fluid flows to the electropotential cell.

The fluid can be essentially any liquid, solution, or suspension. In preferred embodiment, the fluid is an aqueous slurry of cellulosic fibers, water, beverages, and other industrial process suspensions and effluents. Examples of contaminants that can be removed very effectively with this process include flexographic inks, conventional inks, microstickies, toner inks, and wax particles, which can be difficult to remove using convention techniques for recycling paper pulp.

The electric field is a high voltage field, preferably generated by a direct current and preferably applied to the fluid by flowing the fluid between an anode and a cathode in a housing of an electro-potential cell. Preferably, the electrical potential is between about 800 and about 6000 volts per inch between the anode and cathode.

The geometric relationship between the cathode and the anode is critical to both power consumption and low-maintenance-free operation of the electropotential cell. Preferably, the high-voltage, low power electropotential cell provides a minimum anode surface area to reduce power consumption, by orienting the anode towards the cathode such that the anode is tapered in the direction of the cathode, by terminating the anode in a sharp point to reduce power consumption and reduce insulating build-up, and by orienting the anode discharge surface area at 90 degrees with respect to the cathode surface. The design of the electropotential cell preferably provides a discharge surface area of the anode which is approximately perpendicular to the cathode surface, and an anode that comprises an elongated rod which tapers to a point in the direction of the cathode.

In a preferred embodiment, the electropotential cell includes a housing having a fluid inlet and a fluid outlet, a fluid flow path being defined therebetween; an anode and a cathode secured within the housing in the fluid flow path; and a variable power supply in electrical connection to the anode and to the cathode effective to create an electric field, preferably a DC electric field, between said cathode and said anode. The power supply preferably provides an electrical potential between about 800 and about 6000 volts per inch between the anode and cathode. Preferably, the anode discharge surface area is perpendicular to the cathode surface, the anode comprises an elongated rod which tapers to a point in the direction of the cathode, and the cathode is in the shape of ring which fittingly engages an inner surface of the housing, so that the fluid flow path extends through the ring.

The housing of the electropotential cell can have a variety of shapes or configuration. In a preferred embodiment, the housing is cylindrical in shape, and the fluid inlet has a central axis that is coextensive with the central axis of the fluid outlet. Alternatively, the housing can have a T- or L-shape, such that the fluid inlet is oriented approximately perpendicular to the fluid outlet.

The decontamination cell preferably comprises an elongated cell that includes (i) a longitudinal axis and an interior surface defining a decontamination chamber; (ii) a fluid inlet end; (iii) an opposed fluid outlet end; and (iv) a light contaminant collection hood within an upper portion of the decontaminating chamber in fluid communication with the chamber and having an upper port for purging light contaminants therethrough, wherein the light contaminants purging is effected by a fluid head which creates a fluid flow gradient within the decontaminating chamber between turbulent flow adjacent the inlet end and laminar flow adjacent the outlet end such that a transitional flow region is at least partially adjacent the collection hood.

Optionally, the method further includes introducing gas bubbles, such as air, into the fluid to assist in the process of separating the contaminants from the fluid. The bubbles preferably have a mean diameter between about 30 and about 60 microns, and preferably are introduced by gas injection into the fluid that is flowing at a velocity between about 3 and 20 ft/sec, more preferably between about 5 and 9 ft/sec.

A method is also provided for killing organisms suspended in an aqueous fluid. The method includes the steps of flowing an aqueous fluid having organisms dispersed therein between an anode and a cathode of an electro-potential cell; and applying an effective electric field across the fluid to kill the organisms, preferably such that the electrical potential is greater than about 1500 volts per inch between the anode and cathode. The method may further include flowing the aqueous fluid through a decontamination cell to separate from the fluid at least a portion of the killed organisms and/or other contaminants, if any, present in the aqueous fluid.

Also provide is a method for increasing the strength of a paper made from lignin-containing cellulosic fibers. The method includes the steps of providing an aqueous slurry comprising the lignin-containing cellulosic fibers and a source of hydroxyl compounds (e.g., sodium hydroxide); applying an effective electric field across the aqueous slurry to adsorb the hydroxyl compounds onto the surface of the lignin in the cellulosic fibers treated thereby; and making paper from the treated cellulosic fibers, whereby said paper has greater tensile strength than paper made from cellulosic fibers not treated with the electric field. Preferably, the electrical potential is greater than about 1500 volts per inch between the anode and cathode. The cellulosic fibers preferably comprise recycled pulp obtained from newspapers, magazines, corrugated containers, and combinations thereof, or thermomechnical pulp or kraft pulp.

### BRIEF DESCRIPTION OF THE DRAWINGS

FIG. 1 is a process flow diagram of one embodiment of a process for decontaminating a recycled pulp stock.

FIG. 2 is a cross-sectional view, in partial cut-away form to show interior cross-sections, of one embodiment of an electro-potential cell, having a T-shaped housing, for use in various decontamination processes.

FIG. 3A is a cross-sectional view, in partial cut-away form to show interior cross-sections, of a preferred embodiment of an electro-potential cell, having a linear or cylindrical housing, for use in various decontamination processes.

FIG. 3B is an end view, in partial cross-section of the electropotential cell shown in FIG. 3A.

FIG. 4 is a graph of fiber strength before and after decontamination.

FIGS. 5A-B are graphs showing improvement in brightness and ERIC as the sample is passed through a decontamination system.

FIG. 6 is a drawing illustrating the adsorption of hydroxyl compounds onto the surface of lignin following complexation by exposure to high voltage electric field, wherein AKD sizing molecules have been bonded to the Na⁺ and H⁺ molecules.

FIG. 7 is a graph showing enhanced tensile strength of paper made from fibers treated with a high voltage direct current electric field.

### DETAILED DESCRIPTION OF THE INVENTION

Improved electropotential cells have been developed which can provide a controlled application of a high voltage electric field to a flowing fluid. This new cell has many useful applications. Non-limiting examples of these applications include neutralizing (i.e. killing) biological contaminants in the fluid and altering a cellulosic pulp suspension to increase paper strength. In a preferred application of treating recycled pulp, the methods and apparatus described herein provide improved neutralization of living organisms and removal rates of these and other troublesome contaminant particles while retaining—and even improving—the pulp fiber quality and strength.

Improved fluid decontamination methods and apparatus also have been developed, which utilize a combination of an electric field and an elongated decontamination cell that separates light and heavy contaminants by gravitational and buoyancy forces. Preferably, these methods and apparatus further include the controlled introduction of gas bubbles into the fluid to enhance the efficacy of the electric field and elongated decontamination cell.

The electric field methods and apparatus described herein improve upon the teachings of U.S. Pat. No. 5,238,538 entitled “Method For Deinking Recycled Fiber By Applying Direct Current Electric Field.” The preferred decontamination cells are those described in U.S. Pat. No. 5,733,413 entitled “Method For Removing Contaminates From Aqueous Paper Pulp” and in U.S. Pat. No. 6,139,684 entitled “Method and Apparatus For Decontaminating Liquid Suspensions.” These patents hereby are incorporated herein in their entirety.

I. Fluids for Treatment of Decontamination

The methods and apparatus described herein can be applied to a wide variety of fluids, in particular aqueous suspensions, slurries, and solutions, for decontamination or other purposes. The methods and apparatus may be adapted for use with non-aqueous and non-liquid fluids. One of the primary applications is the decontamination of aqueous slurries of cellulosic fibers, particularly wood pulp fibers, and more particularly recycled pulp fibers, which frequently are contaminated with contaminants suitable for removal using the methods and apparatus described herein. In a preferred embodiment, the pulp slurry undergoing the decontamination process is at a consistency between about 0.1% and 5%.

Other examples of a suitable fluid include slurries of clay or other minerals, such as in mining or reclamation operations. For example, kaolin clays respond to voltage treatment by selectively removing very small silica particles from the kaolin product. Electric-assisted flotation can remove the charged clay particles from the non-charged silica particles.

Other examples of suitable fluids include industrial waste effluents, particularly waste water from pulp and paper mill operations. In one embodiment, the fluid is any raw water from a non-potable water source (e.g., river, ocean, groundwater), which is to be converted to potable water. Other beverages also may treated with the electric field for sterilization purposes.

Oil emulsions are yet another fluid suitable for use in the methods and devices described herein. For example, high voltage treatment of oil emulsions is used to break the emulsion. In contrast to existing techniques wherein electrode fouling lead to high maintenance and system costs, the present methods and devices prevent electrode fouling with ionic debris.

Those skilled in the art can readily adapt the teachings herein to a variety of fluids.

Separation can be effected by separating charged particles by varying the voltage and reducing the product in steps until each contaminant particle is removed by a series of steps of different charges.

Representative examples of contaminants targeted for removal using the methods and devices described herein include flexographic inks, microstickies, toner inks, conventional inks, wax particles, dirt, sand, metal particles, undesirable living organisms (e.g., bacteria, fungi, algae, and animals in any liquid suspension), and combinations thereof. Of course, a wide variety of other light and heavy contaminants can be removed from the fluid using the decontamination cell.

In addition to the improved removal of micro-stickies and flexographic inks, dyes, such as magenta, can be surprisingly removed from paper pulp liquid suspensions with the present methods and devices.

II. The Decontamination Process and Apparatus

The preferred method for decontaminating a fluid includes the steps of (a) applying an electric field across the contaminated fluid; and (b) flowing the fluid through a decontamination cell to separate from the fluid at least a portion of the contaminants. Preferably, the method further includes the optional first step of introducing gas bubbles into the contaminated fluid. The decontamination methods preferably are conducted in a continuous process.

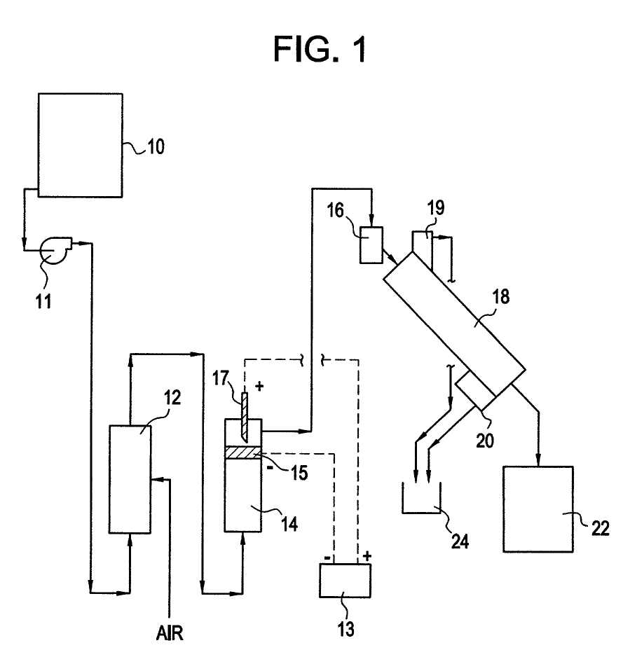

A preferred embodiment of the decontamination process is illustrated in FIG. 1. A contaminated fluid (e.g., a recycled pulp slurry) is pumped from feed stock tank 10 using a pump 11 and into and through air injection system 12. Air bubbles are introduced into the fluid as it passes through system 12. The velocity of the fluid through the air injection system 12 is preferably between 5 and 9 ft/s. The fluid then flows into and through an electropotential cell 14, where the fluid flows through an electric field, which is created between anode 17 and cathode 15 and powered by variable power supply 13. The fluid then flows into a headbox 16. The headbox 16 feeds a decontamination cell 18, which includes a light contaminant collection hood 19 and a heavy contaminant collection trough 20. The fluid velocity in the cell 18 is reduced to purge light contaminants (e.g., inks adhered to air bubbles) through collection hood 19 and to purge heavy contaminants (e.g., sand, staples, glass, dirt) through collection trough 20. These light and heavy contaminates are shown flowing into sewer 24, for additional processing and/or disposal. The decontaminated fluid then flows from decontamination cell into an accepts stock tank 22. In the embodiment where the decontaminated fluid is pulp slurry, the pulp slurry is pumped from the stock tank for subsequent processing, such as bleaching and papermaking.

A. The Gas Injection Process and System

The optional gas injection system is used to enhance subsequent electric and to drive flotation separation processes. Enhanced flotation performances occurs when dissolved air bubbles on fiber/fines surfaces are in close proximity to dispersed or attached contaminant particles. Gas bubbles can be suitably introduced into the fluid by direct gas injection via a sparger (e.g., one or more nozzles or perforated plates), sonication, or any of variety of technologies known in the art.

The introduction of air bubbles is especially preferred in the decontamination of aqueous slurries of recycled pulp fibers. The system should provide intimate mixing of the bubbles and fibers, to bring the air bubbles into contact with the surface of the fibers, and thus in close proximity to contaminant particles adhered to the fibers. These “dissolved” air bubbles are small, highly dispersed particles set onto the fiber surface by water shear and turbulent forces. Removable contaminants are may be dispersed in the aqueous media of the slurry. The infusion of these small air bubbles in close proximity to inks, microstickies, and other contaminants has been determined to significantly enhance decontamination performance.

In a preferred embodiment, air injection is via a sparger injection set into a pulp stock stream that is flowing at a rate between 5 and 12 feet per second. Air injection at 2.5 times stock flow dissolves air bubbles onto the fiber surface. Orifice size is determined by air pressure differential across the orifice and the solids content of the stock flow. Air injection percentages are a ratio of solids flow and the desired dissolved air content. Higher stock back pressure helps reduce the bubble size when discharged from the sparger orifice. Orifice location is set to prevent pluggage from high solids concentration flows.

Air bubble mobility is directly related to the size of the air bubbles. Smaller bubbles have higher velocity and increase the probability of contact with contaminant particles. Higher velocity also increases the bubbles' kinetic energy, an important factor in attachment of an air bubble to a contaminant particle. Dissolved air on a fiber surface has shown to produce many bubbles having a diameter between 40 and 50 microns. The bubble surface area available for contacting and collecting small contaminant particles for a fixed volume of is inversely proportional to the size of the bubbles. For example, if the air volume is 10 percent, air bubbles with diameters of 120 micron will have less total surface area than 10 percent air volume with 40 micron air bubbles. The gas bubbles preferably have a mean diameter between about 10 and about 100 microns, more preferably between about 30 and about 60 microns, and most preferably between about 40 and about 50 microns.

After a contaminant particle comes into contact with the dissolved air bubble system, this contact is not easily lost. This bubble/contaminant system has been found to be relatively stable in a high velocity and high shear environment. Therefore, these contaminant particles can be transported through process piping at high velocity without disassociation. The diameter of such process piping can vary, but preferably is between about ½ and 30 inches (13 mm and 760 mm). Contact time required to produce measurable results in the air injection system is essentially instantaneous for stock velocities between 5 and 9 ft/sec (1.5 m/s and 2.7 m/s). These velocities are standard piping design factors for retaining dissolved air in paper slurries transport. Fluid velocities between about 3 and 20 ft/sec (0.9 m/s and 6 m/s) also may be suitable.

B. The Electric Field and Electropotential Cell

The fluid to be decontaminated is fed through an electric field effective to facilitate the separation of contaminant particles from other components of interest in the fluid and/or to neutralize biological organisms in the fluid. For example, U.S. Pat. No. 5,238,538 describes that charged ink particles can be attracted away from pulp fibers, which typically carry a weak negative charge, and coagulated by application of a direct current electrical field. The electric field is created by an electropotential cell.

In a typical, preferred embodiment, the fluid is pumped or gravity fed through the electric field in a continuous process. Alternatively, the fluid can be fed through the electric field in a semi-continuous process or a batch of the fluid can be subjected to the electric field, and may include moving the electropotential cell through such a batch.

The Electric Field

The electric field is preferably a direct current, or pulsating direct current, electric field. Although an alternating current could also be applied, it has proven to be less desirable than a direct current electric field in some applications.

Power consumed is directly proportional to anode surface area. The geometric relationship of anode discharge surface area (current density) is proportional to power consumed. To minimize power, the anode must also be minimized. The cathode surface area can be large compared to the anode surface area. To treat 100% of the fluid flow, one electrode must encompass the entire flow, or be of sufficient size or surface area. The minimal surface area is the internal circumference of the pipe wall.

Under these circumstances, if alternating current is employed, when the larger cathode surface becomes the anode, the surface coats over or insulates with ionic material. Low pipe wall liquid velocities cannot keep the surface clean and the unit will quickly become insulated from the liquid, halting efficient operation, and thus will require periodic, likely frequent and costly, manual cleaning. In contrast, if direct current is employed, the anode remains the anode and the cathode is found to not attract these unwanted ionic particles, thereby permitting the process to remain in continuous operation without periodic cleaning.

The electrical potential typically should be between about 800 and about 5,000 volts per inch (“vpi”) between the anode and cathode (30 and 200 volts/mm). The preferred voltage for economical operation is between about 1,000 and about 2,000 vpi (40 and 80 volts/mm), and more preferably between about 1,400 and about 1,700 vpi (50 and 70 volts/mm). Greater voltages can cause excessive ionization at the anode, which significantly increases current consumption and consumption of the anode material. Lower voltages can reduce the efficacy of the electrical field on removal of inks and sticky particles, and can produce less work energy available for moving the contaminant particles to an air bubble surface.

Biological activity is effectively neutralized by application of voltages above 800 vpi (30 volts/mm). While not be bound to any particular theory, it is believed that such voltages coagulate cell plasma, halting life in the biological organism. A life form is incapable of restoring the plasma after coagulation.

The Electropotential Cell

The electropotential cell produces and applies the electric field. It holds the electrodes in the proper orientation and isolates them from ground potential.

The electropotential cell is specifically designed to apply a voltage to a liquid as it flows through the device, while maintaining continuous electrode cleaning during operation. The devices produce a maximum effect with minimal power consumption. The device also provides a combination of improved injection for floatation, proper air bubble size for maximum performance, correct flow velocity, dimensional correlation to flow velocity, and application of the electro-potential field with respect to flow direction. Capital equipment costs for these devices can be substantially less than for traditional technology.

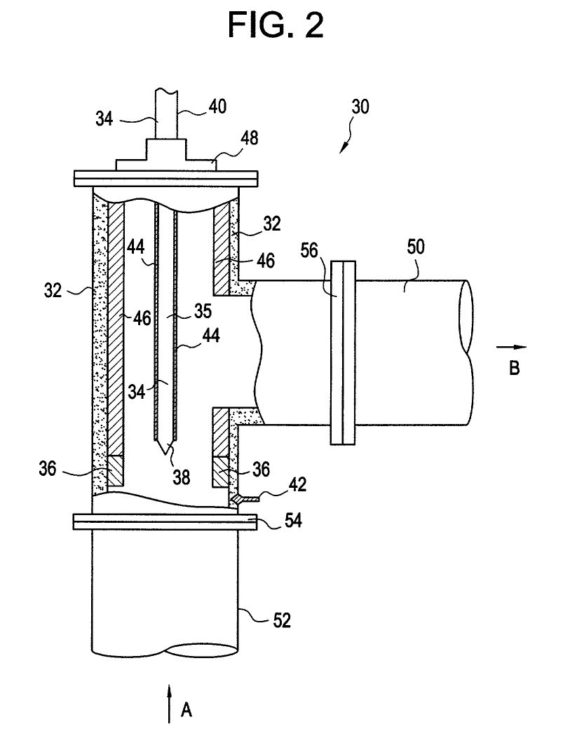

One embodiment of the electropotential cell is shown in FIG. 2. The electropotential cell 30 has T-shaped main housing 32, in which anode 34 and cathode 36 are secured. The housing 32 has a fluid inlet 54 and a fluid outlet 56, which are oriented perpendicularly to one another and are positioned such that the fluid flowing through the housing 32 between the inlet 54 and outlet 56 must flow through the electric field created between the anode 34 and the cathode 36. Fluid flow into the cell 30 is shown by arrow A, and fluid flow out of the cell 30 is shown by arrow B. The direction of fluid flow through the cell can, however, be reversed and the cell operated effectively.

Inlet 54 has a flange for connection to insulating pipe 52. Outlet 56 has a flange for connection to insulating pipe 50.

The anode 40 is attached to the housing 32 by a flanged connection with anode seal 48. The anode has a base or connection end 40 and an opposed distal end 38. The distal end portion of the anode tapers to a point. The cathode 36 is connected to the variable power supply (not shown) via connection 42, and the anode 34 is connected to the variable power supply via connection end 40.

The non-tapering portion 35 is covered by a first insulating material 44, leaving the tapering portion uncovered. Depending on the angle or degree of tapering, some of the tapering portion (other than the tip) may also be insulated. The interior walls of the housing 32 are also substantially covered with a second insulating material 46. While essentially any insulating material could be used, plastic materials are the preferred construction material because they are insulating in nature and can be fabricated using welding sealing construction practices. Non-limiting examples include poly(vinyl chloride) (PVC) and polyethylene pipes and sheets, which are easy to weld and drill using conventional techniques.

The thickness required depends on the particular application and electrical insulation needed. In a large cell, the thickness can be, for example, two to three inches (50 to 80 mm) or more, to both insulate and aid the device in withstanding the high pressures and high temperatures common with paper furnishes in the industry.

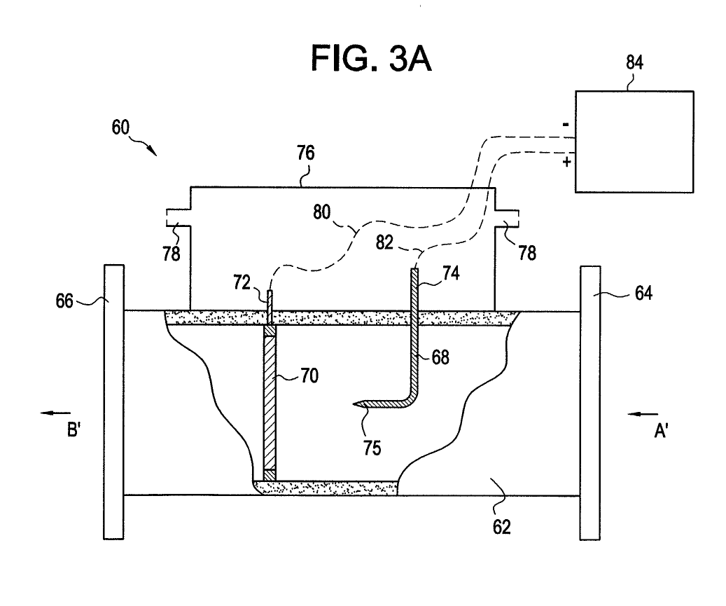

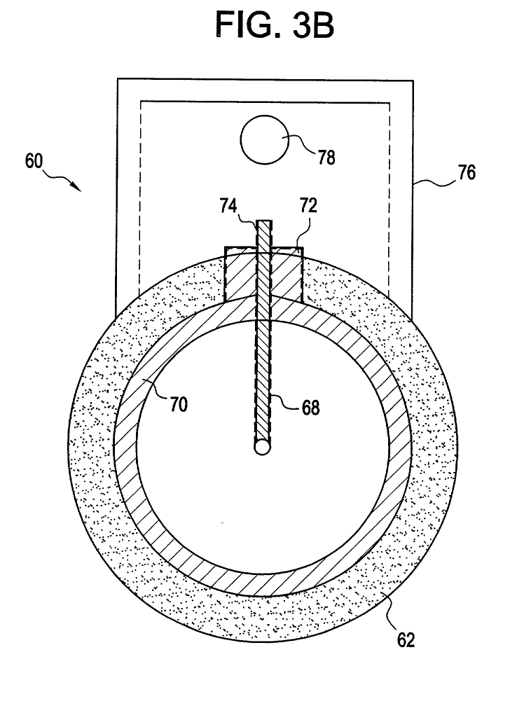

A preferred embodiment of the electropotential cell is shown in FIGS. 3A and 3B. The electropotential cell 60 has a linear or cylindrically shaped main housing 62, in which anode 68 and cathode 70 are secured. The housing 62 has a flanged, fluid inlet 64 and a flanged, fluid outlet 66, which are oriented along a common axis at opposite ends of the housing and are positioned such that the fluid flowing through the housing 62 between the inlet 64 and outlet 66 must flow through the electric field created between the anode 68 and the cathode 70. Fluid flow into the cell 60 is shown by arrow A′, and fluid flow out of the cell 60 is shown by arrow B′. This is the preferred direction of fluid flow through the electric field, although the direction of fluid flow through the cell can be reversed and the cell operated effectively.

The anode 68 is secured to and extends through a side wall of the housing 62. The anode 68 has a base or connection end 74 and an opposed distal end 75. The distal end portion of the anode tapers to a point. The anode 68 is L-shaped with the distal end portion being positioned substantially coextensive with the central axis of the interior of the housing 62.

The ring-shaped cathode 70 is secured within the interior of the housing adjacent a circumferential portion of the interior wall. The cathode 70 includes a cathode connection 72 that extends through a sidewall of the housing 62. The anode connection end 74 and the cathode connection 72 are electrically connected to power supply 84 via wires 82 and 80, respectively. The anode connection end 74 and the cathode connection 72 are contained in electrode connection box 76, which includes vents 78.

While FIGS. 2 and 3 show an electropotential cell having a T-shaped and a linearly shaped housing, other configurations are envisioned. For example, the housing could be in a Y-shape, with the anode located in one branch and fluid flowing in and out of the other two branches. In such an embodiment, the fluid flow direction change in the housing would be between about 20 and 45 degrees, more preferably about 30 degrees. (For comparison, the fluid flow direction change would be 90 degrees in the T-shape embodiment described herein and 0 degrees for the linear embodiment described herein.)

The electrodes (anode and cathode) can be constructed of any suitable conductive material. Representative examples include copper, brass, stainless steel (e.g., 316 SS), and nickel. Copper was found to be adequate across a range of pH and pulp slurries without adverse corrosion.

Important to the commercial feasibility of the methods and devices, it was discovered that the geometric relationship between the cathode and the anode is critical to both power consumption and maintenance-free (or low maintenance) operation of the electropotential cell. Preferably, the high-voltage, low power electropotential cell of the present invention provides a minimum anode surface area to reduce power consumption. It was discovered that this minimum anode surface could be achieved by orienting the anode towards the cathode such that the anode is tapered in the direction of the cathode, by terminating the anode in a sharp point to reduce power consumption and reduce insulating build-up, and by orienting the anode discharge surface area at 90 degrees with respect to the cathode surface.

Establishing an electric field in an aqueous suspension containing many charged particles normally results in coating of the anode and reduction or loss of electrical contact with the cathode. To prevent excessive anode coating and consequent electrical contact degradation, it was found useful to use high fluid velocities, which causes adhered particles to be dislodged from the anode. Typically, fluid velocities of 4 to 20 feet per second, or more preferably 5 to 9 feet per second generally, are needed to effect this anode cleaning. This advantageously allows continuous operation of the electropotential cell without or with less frequent process downtime (i.e. stoppage) for anode cleaning. The self-cleaning of the anode is further enhanced by the shape of the anode. Specifically, the anode preferably ends in a very sharp point (see FIG. 2), because particles have difficulty sticking to a very sharp point under high flow rate conditions.

The anode design is also important in controlling power consumption. Minimum power reduces electrical operating costs and anode material consumption. Power consumption is directly proportional to the anode discharge surface area. To minimize anode surface area, the anode preferably is oriented towards the cathode such that the anode is tapered in the direction of the cathode. The geometry or shape of the tapering portion of the anode can be varied. For example, it can be substantially conical, pyramidal, or obelisk shaped. The anode preferably tapers to a sharp point, as an electric field is established with minimal current because the surface area of a point is very low. Preferably, the tapering is such that the tip slope is about 15 degrees, measured from the center of the electrode tip back.

The anode discharge surface area preferably is approximately perpendicular to the cathode surface. The distance between the cathode and the point of the anode preferably is between about 0.25 inches and 1.5 inches (6.4 and 38 mm), more preferably about 0.75 inches (19 mm). Nevertheless, any operable distance of separation between the cathode and anode is contemplated, and can be readily determined for a particular electropotential cell and application. Typically, the cell cross-section or diameter taken at the cathode and a 45° angle is constructed from the cathode surface outward toward the center of the cell. The location of the intersection of the 450° angle and the cell mid-section determines the anode distance from the cathode.

The width of the cathode preferably is between about 0.5 inch and 2 inches (13 and 51 mm), more preferably about 1 inch (25 mm). Nevertheless, any operable width of the cathode is contemplated.

The non-tapered portion of the anode shaft preferably has a diameter of about ⅛ inch (3.2 mm). This size is derived as a compromise between a large diameter to provide the needed mechanical stability under high liquid flow rates and a small diameter to provide minimal electrical current discharge surface area. The size produces an acceptable current discharge for low power consumption, although a larger discharge surface area will work but will require more electrical current. A smaller electrode would decrease current, but would be less mechanically strong and more likely to break or be deformed during operation. In various applications, it is contemplated that other operable anode dimensions may be used or designed in light of these considerations.

C. The Decontamination Cell and Separation Process

Preferably, the decontamination cell is one described in U.S. Pat. Nos. 5,733,413 and 6,139,684, to Lawson et al. The decontamination cell also can be essentially any flotation or dissolved air separation unit known in the art. For example, the decontamination cell can be based on any device used to remove dissolved air and other contaminates from the fiber surface and conduct them out of the pulp slurry device.

In a preferred embodiment, the decontamination cell comprises an elongated cell that includes (i) a longitudinal axis and an interior surface defining a decontamination chamber; (ii) a fluid inlet end; (iii) an opposed fluid outlet end; and (iv) a light contaminant collection hood within an upper portion of the decontaminating chamber in fluid communication with the chamber and having an upper port for purging light contaminants therethrough, wherein said light contaminants purging is effected by a fluid head which creates a fluid flow gradient within the decontaminating chamber between turbulent flow adjacent the inlet end and laminar flow adjacent the outlet end such that a transitional flow region is at least partially adjacent the collection hood. The elongated cell preferably also includes a heavy contaminant collection trough for separating heavy contaminants from the fluid.

D. Separation Enhancing Agents

Surfactants and other chemical additives can be added to the fluid to enhance separation of the contaminants from the fluid and/or from valuable components (e.g., pulp fibers) of the fluid. These separation-enhancing agents are well known in the art.

When decontaminating paper pulp, anionic surfactants are less preferred than non-ionic surfactants. Standard collector chemistries including fatty acid derivatives are proven most effective in removing small dispersed particles in the presence of an electric field without over dispersing the remaining small contaminant particles.

Surfactants in combination with fatty acids are the preferred agents. Surfactants alone cause excessive dispersion when subject to high mechanical shear. Shear forces produced to dissolve air onto fiber surfaces in the presence of a surfactant chemical environment produces over dispersion and reduces the effectiveness of the electric field.

III. Application, uses, and Benefits

The electropotential cell described herein can be used advantageously in a variety of processes. Some processes such as the decontamination of recycled paper fibers or other cellulosic pulp suspensions preferably include the decontamination cell, while other processes such as biological neutralization and paper strengthening need not include the use of the decontamination cell.

A. Cellulosic Pulp Fiber Decontamination

As described herein, one of the primary applications for the decontamination methods and apparatus is to remove inks, waxes, and stickies from recycled furnish. Representative examples of such furnish include old newspapers, old corrugated containers, and mixed office waste. Treatment using these methods and apparatus produce decontaminated pulp without substantial and undesirable losses in pulp quality. In fact, it was unexpectedly discovered that gains in paper wet and dry strength are obtainable using these methods.

It was also discovered that the methods and apparatus could be applied to recover fiber to improve fiber yield and thus and mill yield. Many mills currently sewer (i.e. discard) fiber in order to decontaminate the process, purging ink and microsticky particles along with fiber from paper stock systems. This results in poor fiber yield. Much of this sewered fiber can be cleaned using the methods and apparatus described herein to recover lost fiber and improve yield.

The methods and devices provide high contaminant removal efficiencies and low losses of liquid and solid product. The devices improve removal efficiency without degrading optical properties, such as brightness, of the pulp.

B. Increasing Paper Strength

The application of the electric field to paper fiber slurries can found to significantly and surprisingly improve strength properties of the paper made therefrom, as compared to paper made from untreated fibers. As described in Example 3 below, wet and dry tensile strength and burst strength are improved by treatment of the pulp fibers with an electric field. It is believed that this strength enhancement is caused by complex absorption of hydroxyl compounds (e.g., from residual caustic, such as NaOH) onto the lignin surface, which occurs due to the electric field. This complexation is believed to increase the number of hydrogen bond sites over the number of sites naturally present on the lignin surface. Examples of typical lignin groups are guaiacyl, syringyl, phenolic ester and β-aryl ether. More bonding sites results in greater paper strength.

In this application, the electric field is preferably one having an electrical potential greater than about 1,500 volts per inch between the anode and cathode (60 volts per mm), more preferably between about 3,000 and about 6000 volts per inch between the anode and cathode (100 to 240 volts per mm).

It is contemplated that this electric field treatment is performed by flowing an aqueous slurry of cellulosic fibers through an electropotential cell, preferably the electropotential cells described herein. The aqueous cellulosic slurry preferably includes a lignin-containing wood fibers, such as thermomechanical pulp, recycled OCC, recycled ONP, recycled OMP, or a combination thereof, although non-wood lignin-containing fibers are also suitable for use in this method. Strength enhancement is a function of applied voltage and fiber lignin structure. Fiber grades containing lignin are improved, while bleached fiber has been shown to be virtually unaffected due to the removal of lignin during the bleaching process.

The aqueous slurry also should have trace quantities of sodium hydroxide. Quantitatively, the caustic is needed to adjust the pH to slightly above neutral pH. It is believed that when caustic is fixed onto the lignin surface, a complex phenolic is formed along with carboxyl groups. Under electrical charge, several carbonyl groups along with hydroxyl groups complexed onto the lignin surface remain, providing a strong bond for strength improvement. These bonds do not appear to be affected by pH swings and remain present.

Data collected from tests show a direct correlation to voltage and pH. As pH increases, dry tensile increase is less dramatic than wet tensile. Wet tensile under higher pH conditions can increase by a factor of approximately four. The data shows that high voltage treatment at neutral pH increases dry tensile drastically and that at a pH of 8.5 wet tensile improvement is greater than dry tensile improvement.

Therefore, specific papers, having specific strength properties, can be tailored by as desired (with certain limitations) by controlling the pH and voltage used with a specific fiber species. The electric field treatment process described herein is useful with both wood and non-wood lignin-containing fibers. Representative examples of these non-wood fibers include kenaf, straw, rice, and hemp, as well as other species commonly known in the industry. This is further described in Examples 4 and 5 below.

This increase phenomenon has several advantages and benefits. For example, greater strength can enable a reduction in basis weight of paper required to achieve various performance properties. A lower basis weight translates into less fiber needed and thus substantial cost savings. Another advantage is the possibility of combining various wood and wood-free fiber species to produce a specific paper product to meet a specific demand or requirement.

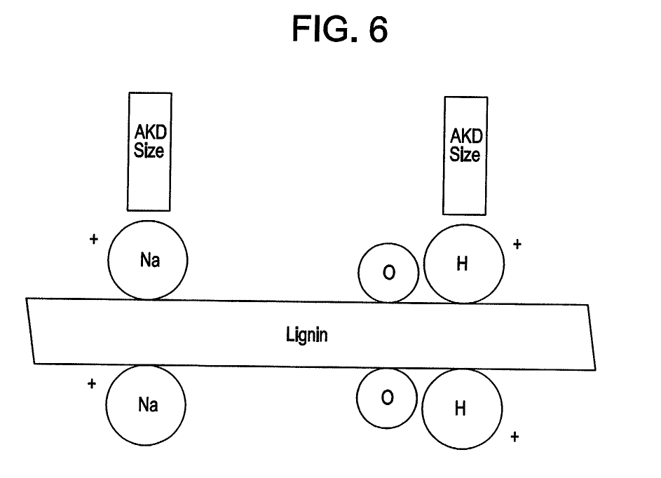

Another benefit is that wetting agents, sizing agents, or other paper processing agents used in the paper manufacturing process can be modified or eliminated due to the increased number of binding sites present in the pulp fibers, as a result of the electric field treatment process described herein. For example, AKD sizing molecules can be bound to the complexed Na⁺ and H⁺ present on the lignin surface (See FIG. 6). This eliminates the need to add other agents to facilitate binding between the AKD sizing molecules and the lignin surface. In one embodiment, it will be possible to eliminate such linking molecules from currently employed complex polymeric AKD sizing molecules.

The use of the strong electric potential for treating various polymer compounds to produce new structures also is contemplated. Monomers and polymer compounds maybe formed by a strong link or bonding between the polymeric compounds. For example covalent, coordinate, and ionic linkages can be manipulated for efficient formation of compounds that otherwise are difficult to produce.

C. Biological Neutralization

Biologic neutralization refers to the use of the electric potential cell described herein to reduce the pathogenicity of an undesirable living organism in any liquid suspension. For example, the methods and apparatus can be used to treat aqueous pulp suspensions and aqueous effluents from pulp and paper mill operations. The methods and apparatus also can be used to treat maritime bilge water on a boat, or to sterilize drinking water or other beverages. Optionally, the decontamination cell can be used to remove the killed organisms.

The method preferably uses a high voltage electropotential field to effect sterilization of biological activity. For example, electric fields of about 1,500 volts per inch (60 volts per mm) and greater have been demonstrated to be effective in controlling the growth of microorganisms. The process provides an economical means of treating and controlling biological activity in paper mill wastewater before release into the environment.

IV. Testing for Contaminant Removal

The following testing procedure was developed for verification of improved contaminant removal, because prior test methods—for example to investigate microsticky contaminants in recycling old corrugated containers (OCC)—have not been fully developed. These prior methods typically use a gas chromatograph with a cyclohexane solvent to dissolve the particles from a pulp fiber mat, which require laboratory facilities, procedures, and technicians beyond those routinely available in mills. In contrast, this presently described test procedure simplifies the process and can be accomplished with personnel normally skilled in the art of producing a standard TAPPI hand sheet for routine testing purposes.

A standard 4 to 8 gram fiber sample is collected from a feed stock stream. If a 500 ml sample is collected, it is treated with 6 ml of alum and stirred for 30 seconds, which will collect the anionic solids and fines. After stirring alum into the sample, add 6 ml of a high molecular weight anionic polymer, which will collect the cationic particles charged when the alum was added. Stir the sample again for 30 seconds.

Allow the sample stand until movement stops and the solids collect into a large mass and begin to separate from the water. Visually inspect the effluent to ensure that it is clear. If the effluent is not clear, then there was insufficient alum or polymer added. Repeat the first step again by adding 4 ml of alum and stir, and then add 6 ml of polymer and stir again. The effluent should become clear after several minutes of settling.

Weight a filter pad, and then pour the 500 ml sample contents onto the pad installed in a vacuum-assist drainage funnel. Collect the effluent and visually inspect for clarity. If the effluent remains clear, then the microsticky particles from the sample effluent will have collected on the top of the filter pad.

After drainage is complete, remove the filer pad from the funnel and roll the sample between blotter papers to drain the excess moisture and to attach some fibers to the microsticky particles residing on the surface of the filter paper.

After rolling is complete and the sample is wet, remove the fibers from the filter paper. Either a standard hand roll or TAPPI press can be used; the results would be similar. Pull the fiber mat from the filter paper, and then lightly brush the filter paper surface (e.g., using a finger) to remove all fibers that are not attached to a sticky surface. The only fibers that can stick are small fines that normally would pass a 36-mesh screen test. Larger fibers will pull away from the microstickies, leaving the smaller fines imbedded into the filter pad surface; these are not easily removed. The filter paper surface should not be smooth; rather, it should have a slightly textured surface. Small fiber fines and microsticky particles will remain imbedded in the textured surface instead of being wiped away. A smooth filter pad surface will not produce better results.

It has been proven that if the system temperature is above 65° C., then the microsticky particles are contained within the effluent and not on the fiber.

Dry and weigh the sample, and subtract the original filter weight from the sample weight. The difference in weight is the quantity of microsticky particles in the filter pad.

This sampling procedure can be accomplished in about 8 minutes. It is much less involved than using a gas chromatograph, which can take five hours of lab work to produce one result.

In another embodiment, the microsticky content on the filter pads can be measured using optical brightness as a differential between original and final brightness or in combination with differential pad weight. There would be an obvious correlation to the amount of material trapped on the filter pad and brightness shift after the test procedure.

There is another procedure for measuring the content of wax particles contained in with the micro-sticky particles. Separation of these particles may not be easily distinguished using the above method. The same test procedure would be followed for wax particles. Microsticky and wax particles will be distributed across the filter pad surface. In that case, the wax particles will be counted as microstickies.

The devices and methods described herein will be further understood by reference to the following non-limiting examples.

### EXAMPLE 1

Electropotential Neutralization of Biological Contaminants

Three water samples were obtained from a river. One sample was treated with a low voltage electric field, and a second sample was treated with a high voltage electric field. The third control sample was untreated.

The samples were placed in a petri dish and the biological contaminants therein allowed to incubate. Petri dishes were filled with standard agar for common biological growth to be exposed at room temperature. The treatment time was a standard 36 hours. Each sample was visually inspected for colony growth spots in the clear agar. Microscopic inspection of the viewing area on colony count determines the effectiveness. This method was employed to determine the low threshold voltage for a kill on these common microorganisms.

The untreated sample, (control) agar was completely clouded with colonies. The 800 volt per inch (30 volts per mm) was slightly spotted, and the 1,500 volt per inch (60 volts per mm) was completely clear with no observable colonies. In other words, the high voltage treated sample was completely clear of this biological activity. It was discovered that 800 volts per inch (30 volts per mm) is the approximate lower threshold for treatment. Voltages above this limit provided significant levels of control of biological activity. At 1,500 volts per inch (60 volts per mm), complete control was achieved. It is contemplated that 5,000 volts per inch (200 volts per mm) or higher is possible to have a significant effect on viruses and other hard-to-kill microorganisms in water treatment.

### EXAMPLE 2

Wax Removal

Pulp furnish from recycled old corrugated containers (OCC) contains highly dispersed wax particles. These wax particles are troublesome contaminants, which can damage paper machine clothing, decrease water drainage, reduce paper machine speeds, lower productivity, and can cause paper sheet blemishes and defects. Effective techniques for removing this wax have herebefore not been developed. It was discovered, however, that this wax can be effectively removed using the electric field processes described herein.

A sample of OCC recycled pulp (20 wt % wax) was taken before (feed sample) and after treatment (accepts sample). As with the other procedures, higher voltages generally are more effective in removal of wax than lower voltages. Preferred wax treatment voltages are between 3,000 and 5,000 volts per inch (100 to 200 volts per mm) or higher. Treatment time is instantaneous. Typical stock (i.e. fluid) flows are between 5 and 9 feet per second (1.5 and 3 m/s), which translates to the fluid being between the cathode and anode for a few milliseconds, which is sufficient in duration for wax and other contaminants to attach to dissolved air bubbles.

Sampling for wax removal typically is a difficult process. It was discovered, however, that using a simple water drop or water absorption method is very effective procedure for quantifying the presence or absence of wax in a paper sample. First, hand sheets were made from these samples using the standard MK Sheetmaker. Then, a 4 to 6 mL drop of water is set on the sheet (30×15 cm), and allowed to stand/absorb for three minutes. The spread of water, in distance is measured. Wax, of course, retards water absorption. If the treated sample water spread is significantly increased as compared to the untreated sample, then wax has been removed. The results of this test showed that the water drop remained on the feed sample sheet after the period, while the water drop on the accepts sample sheet had been totally absorbed. This result indicated substantial wax removal by the electric field treatment process.

This process is significantly improved over using gas chromatograph procedures, in that samples can be tested in a manner of minutes verses days, lower the cost of sampling, allowing for a greater number of samples in a short period of time.

### Example 3

Fiber Strength Enhancement, Wood Pulps

It was surprisingly discovered that the application of the electric field to paper fiber slurries can significantly and surprisingly improve strength properties of the paper made therefrom, as compared to paper made from untreated fibers.

Tests were conducted using the Thwing-Albert tensile tester, model (QC 1000) for comparisons of treated and non-treated fiber. Samples were treated using various voltages ranging from 3,000 volts per inch (120 volts per mm) through 5,700 volts per inch (220 volts per mm). Treated fiber sample sheets were prepared on the MK Sheetmaker (12 Garden Street, Danvere Mass. 01923). Samples were then prepared using TAPPI tensile test procedure (494 om-88).

Typical tests show dry tensile gains for TMP (Thermal Mechanical Pulp) to average 65% gain in dry tensile and 200% gain in wet tensile. Similarly, OCC and brown grade fibers made from softwood Kraft gain 55% dry tensile and 300% wet tensile strength.

All lignin containing fibers show a significant increase in wet and dry tensile, depending on the applied voltage and water system pH. Residual caustic has a significant impact on brown fiber grades. It is believed that the strength enhancement is achieved by complex absorption of hydroxyl compounds onto the lignin surface (which occurs by application of the electric field), thereby increasing the number of hydrogen bond sites for enhancing strength. These sites are in addition to those naturally present on the lignin surface.

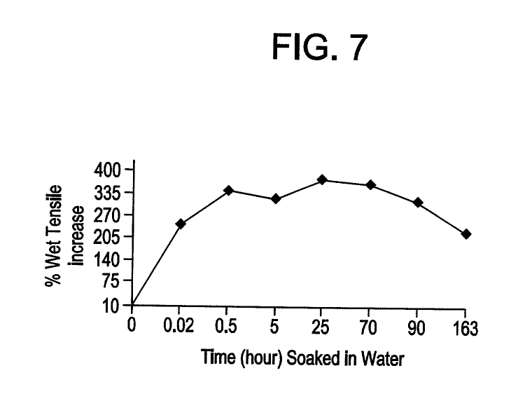

Wet and dry burst strength tests and tensile strength tests were conducted on samples of OCC recycled paper fibers, thermomechanical pulp (TMP), groundwood pulp, bleached softwood Kraft pulp (BSWK), bleached hardwood Kraft pulp (BHWK), old newspapers (ONP), and mixtures of old magazines and old newspapers (OMG/ONP). Wet burst strength was improved more than other properties. Wet burst on OCC showed an improvement of over 300%. TMP, OCC, and groundwood showed a 25 to 60% increase in wet and dry burst and tensile strength. ONP showed a 16 to 20% increase in wet and dry burst and tensile strength. Results are shown in FIG. 7.

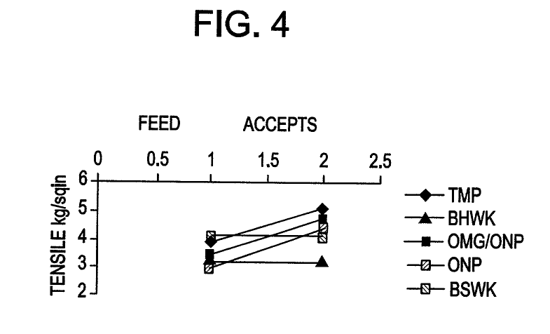

Tensile strength of several of these fibers before and after treatment is shown in FIG. 4 fo. The X-axis is 2 points: The left being the untreated sample and the right being the treated sample. The difference between left and right data points is the percentage gain in strength. Percentage is calculated as (feed tensile measurement)−(accepts tensile measurement) divided by (feed tensile measurement), which is the percentage gain in strength with respect to the untreated sample.

### EXAMPLE 4

Fiber Strength Enhancement, Non-Wood Pulps

Wet strength tests on wood-free, lignin-containing fiber were conducted. High voltage treated paper samples produced on the MK Sheetmaker were soaked in water for up to 163 hours (approximately 7 days) and the wet strength remained 200% above the untreated control sample.

A sample using kenaf showed a dry tensile increase of 212% following a high voltage treatment at a pH of 8.4, and a wet tensile increase of 158%.

### EXAMPLE 5

Flexographic Ink Removal

A 100% mixture of flexographic printed newsprint was pulped at 5% consistency and pH of 8.0. Stock was diluted to 1.7% consistency and the temperature maintained at 65° C. This stock was treated with applied voltages of 800 to 1500 vpi.

To evaluate contaminant cycle up effects normally encountered in a closed loop pulp mill operation, the effluent was reused. Four complete cycles were evaluated. Effluent from the previous pass was kept and used as pulper and washer dilution. The most effective and efficient process for ink removal was a pre-flotation stage, washing, and flotation on screen effluent. This deinked effluent went back to pulping, washer stage water, and washer dilution. All tests reported use this process.

The process used a medium consistency flotation stage followed by a single washer stage and flotation of washer effluent before being sent back to pulping. This deviated from traditional washer systems that use DAF, (Dissolved Air Flotation) on washer effluents at a 100% solids loss. The washer became a stock thickener for pulp mill high density storage. Flotation included stock pretreatment at high electro-potential. Yield from this system was 98% verses 80% with traditional washing systems employing DAF on effluent. An attempt was made to keep paper furnish constant from pass to pass to study the effluents affect on each step in the process.

The second pass temperature was lowered to 100° F. to produce very high ERIC (Effective Residual Ink Concentration) in the effluent water and many high ink loaded fine particles. Success was determined on passes three and four, if the effluent ink reduced and brightness improved. This would mean that the process worked to remove the very small ink particles.

Significant results were achieved with 1500 vpi.

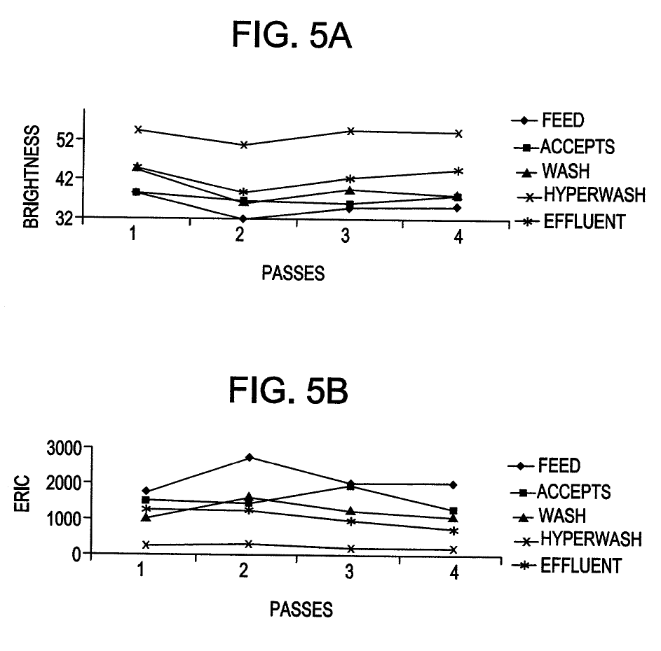

A brightness gain was encountered after 4 uses of the effluent. For example, the results demonstrated that feed brightness was 36 and deinked stock was 54, a gain of 18 points on the fourth pass. Other results are shown in FIGS. 5A-B.

Suspended ink particles in the effluent did not cycle up as normally encountered with traditional deinking processes containing high quantities of water based flexographic inks. Therefore, redeposition of water based inks is not a concern using all flexographic inks. Both the main stock and effluent were treated using high voltage. Hyper-wash ERIC values are approximately 220 ppm throughout the trial, also indicating that the ink is free and not mechanically fouled in the fiber producing higher efficiencies and a simple washing stage.

All ink counts in ppm (parts per million) and brightness measurements were produced on the (Technidyne) meter, (industry standard) using an infrared wavelength of 950 nanometers.

### EXAMPLE 6

Removal of Microstickies

Tests were also conducted on 100% Post-It Note furnish. Tests were conducted which demonstrated a substantial or complete reduction in microstickies following treatment with the processed described herein. Visual observation of samples from OCC furnish showed large contaminant particle reduction.

### EXAMPLE 7

Dissolved Air Flotation (DAF) Fiber Reclamation

Many paper mills use DAF systems to purge contaminants from the process. This purging, however, sends fibers to the waste stream. While the warm water is recovered, the solids, including the fibers, are discarded, thereby lowering the mill efficiency. It has been discovered that this rejected fiber can be reclaimed and effectively decontaminated (at least of ink contaminants) using the processes described herein.

Solids samples were collected from an existing ONP operation using different surfactants. Flotation was performed at about 1.8% solids consistency. High electrostatic pretreatment was employed before flotation. Three flotation passes were used in this evaluation. The GE brightness of the rejects before and after treatment was determined.

Average brightness gain using these solids was above 20 points. Process accepts average ERIC (Effective Residual Ink Concentration) values were slightly above 200. Hyperwash and infinite flotation would produce a maximum 10 points of brightness gain and a 720 ERIC concentration. Significant increase in brightness was not achievable without the electrostatic assist.

Using DAF rejects as a feed stock has shown the potential to drastically increase mill yield to the mid 90 percentile. Process accepts freeness was much improved over the feed stock. With less air content in the accepts than feed stock slurry, drainage will not be compromised using these solids. Mill water closure does not mean an increase in dirt and ink contaminated effluents. It is also contemplated that high solids levels of 2.5% and above can be effectively treated using the process mentioned.

Modifications and variations of the methods and devices described herein will be obvious to those skilled in the art from the foregoing detailed description. Such modifications and variations are intended to come within the scope of the appended claims.

We claim:

1. A method of decontaminating a fluid comprising:
(a) applying an electric field across a fluid having contaminants dispersed therein; and
(b) flowing the fluid through a decontamination cell to separate from the fluid at least a portion of the contaminants.

2. The method of claim 1, wherein the fluid comprises an aqueous slurry of cellulosic fibers.

3. The method of claim 2, wherein the fluid comprises an aqueous slurry of recycled wood pulp fibers.

4. The method of claim 3, wherein the recycled wood pulp fibers are obtained from newspapers, magazines, or corrugated containers.

5. The method of claim 2, wherein the cellulosic slurry has a consistency of between about 0.1 and 5%.

6. The method of claim 1, wherein the contaminants comprise particles selected from the group consisting of flexographic inks, conventional inks, microstickies, toner inks, wax particles, and combinations thereof.

7. The method of claim 1, wherein the electric field is generated by a direct current.

8. The method of claim 1, wherein the electric field is applied to the fluid by flowing the fluid between an anode and a cathode of an electro-potential cell.

9. The method of claim 8, wherein the electrical potential is between about 800 and about 6000 volts per inch between the anode and cathode.

10. The method of claim 9, wherein the electrical potential is between about 1000 and about 2000 volts per inch between the anode and cathode.

11. The method of claim 10, wherein the electrical potential is between about 1400 and about 1700 volts per inch between the anode and cathode.

12. The method of claim 8, wherein the discharge surface area of the anode is approximately perpendicular to the cathode surface.

13. The method of claim 8, wherein the anode comprises an elongated rod which tapers to a point in the direction of the cathode.

14. The method of claim 8, wherein the electropotential cell comprises a cylindrical housing in which the anode and cathode are secured, said housing having a fluid inlet through which the fluid enters the housing and a fluid outlet through which the fluid is discharged from the housing after passing through the electric field.

15. The method of claim 14, wherein the housing is cylindrical in shape, the fluid inlet having a central axis approximately coextensive with the central axis of the fluid outlet.

16. The method of claim 8, wherein the electropotential cell comprises a T- or L-shape housing in which the anode and cathode are secured, said housing having a fluid inlet through which the fluid enters the housing and a fluid outlet through which the fluid is discharged from the housing after passing through the electric field, the fluid inlet being oriented approximately perpendicular to the fluid outlet.

17. The method of claim 1, wherein the decontamination cell comprises:
an elongated cell that includes:
i. a longitudinal axis and an interior surface defining a decontamination chamber;
ii. a fluid inlet end;
iii. an opposed fluid outlet end; and
iv. a light contaminant collection hood within an upper portion of the decontaminating chamber in fluid communication with the chamber and having an upper port for purging light contaminants therethrough,
wherein said light contaminants purging is effected by a fluid head which creates a fluid flow gradient within the decontaminating chamber between turbulent flow adjacent the inlet end and laminar flow adjacent the outlet end such that a transitional flow region is at least partially adjacent the collection hood.

18. The method of claim 17, wherein the elongated cell further comprises a heavy contaminant collection trough for separating heavy contaminants from the fluid.

19. The method of claim 1, further comprising, before step (a), introducing gas bubbles into the fluid, wherein, in step (b) the decontamination cell separates from the fluid at least a portion of the bubbles with the contaminants.

20. The method of claim 19, wherein the gas consists essentially of air.

21. The method of claim 19, wherein the bubbles have a mean diameter between about 30 and about 60 microns.

22. The method of claim 21, wherein the bubbles have a mean diameter between about 40 and about 50 microns.

23. The method of claim 19, wherein the gas bubbles are introduced by gas injection into the fluid, which is flowing at a velocity between about 3 and 20 ft/sec.

24. The method of claim 23, wherein the velocity is between about 5 and 9 ft/sec.

25. A method of killing organisms suspended in an aqueous fluid comprising:
flowing an aqueous fluid having organisms dispersed therein between an anode and a cathode of an electro-potential cell; and
applying an effective electric field across the fluid to kill the organisms.

26. The method of claim 25, wherein the electrical potential is greater than about 1500 volts per inch between the anode and cathode.

27. The method of claim 25, further comprising flowing the aqueous fluid through a decontamination cell to separate from the fluid at least a portion of the killed organisms and/or other contaminants, if any, present in the aqueous fluid.

28. A recycled cellulosic pulp decontaminated by the method of claim 1.

29. An electropotential cell for treating a flowing fluid with an electric field comprising:
a housing having a fluid inlet and a fluid outlet, a fluid flow path being defined therebetween;
an anode secured within the housing in the fluid flow path;
a cathode secured within the housing in the fluid flow path; and
a variable power supply in electrical connection to the anode and to the cathode effective to create an electric field between said cathode and said anode.

30. The electropotential cell of claim 29, wherein the power supply provides an electrical potential between about 800 and about 6000 volts per inch between the anode and cathode.

31. The electropotential cell of claim 29, wherein the electric field is a direct current electric field.

32. The electropotential cell of claim 29, wherein the anode discharge surface area is approximately perpendicular to the cathode surface.

33. The electropotential cell of claim 29, wherein the anode comprises an elongated rod which tapers to a point in the direction of the cathode.

34. The electropotential cell of claim 29, wherein the cathode is in the shape of ring which fittingly engages an inner surface of the housing, said fluid flow path extending through the ring.

35. The electropotential cell of claim 29, wherein the housing is cylindrical in shape, the fluid inlet having a central axis approximately coextensive with the central axis of the fluid outlet.

36. The electropotential cell of claim 29, comprising a T- or L-shape housing in which the anode and cathode are secured, said housing having a fluid inlet through which the fluid enters the housing and a fluid outlet through which the fluid is discharged from the housing after passing through the electric field, the fluid inlet being oriented approximately perpendicular to the fluid outlet.

37. An apparatus for decontaminating a fluid comprising:
an electropotential cell comprising a housing containing an anode and a cathode for applying an electric field a fluid flowing through the housing; and
a decontamination cell in fluid communication with the electropotential cell for separating from the fluid at least a portion of any contaminants dispersed therein.

38. The apparatus of claim 37, further comprising a means for introducing gas bubbles into the fluid before the fluid flows to the electropotential cell.

39. The apparatus of claim 37, wherein the electrical potential is between about 800 and about 6000 volts per inch between the anode and cathode.

40. A method for increasing the strength of a paper made from lignin-containing cellulosic fibers comprising:
providing an aqueous slurry comprising the lignin-containing cellulosic fibers and a source of hydroxyl compounds;
applying an effective electric field across the aqueous slurry to adsorb the hydroxyl compounds onto the surface of the lignin in the cellulosic fibers treated thereby; and
making paper from the treated cellulosic fibers, whereby said paper has greater tensile strength than paper made from cellulosic fibers not treated with the electric field.

41. The method of claim 40, wherein the cellulosic fibers comprise recycled pulp obtained from a source selected from the group consisting of newspapers, magazines, corrugated containers, and combinations thereof.

42. The method of claim 40, wherein cellulosic fibers comprise thermomechnical pulp or kraft pulp.

43. The method of claim 40, wherein the source of hydroxyl compounds comprises sodium hydroxide or another hydroxide-containing compound.

44. The method of claim 40, wherein the electric field is applied to the fluid by flowing the fluid between an anode and a cathode of an electro-potential cell.

45. The method of claim 44, wherein the electrical potential is greater than about 1500 volts per inch between the anode and cathode.

46. The method of claim 45, wherein the electrical potential is between about 3000 and about 5700 volts per inch between the anode and cathode.

47. A paper from made by the method of claim 40.
